(19) United States
(12) Patent Application Publication
(10) Pub. No.: US 2024/0123393 A1
(43) Pub. Date: Apr. 18, 2024

(54) Carbon Dioxide Removal System

(71) Applicant: Klaus J. Hermann, Downingtown, PA (US)

(72) Inventor: Klaus J. Hermann, Downingtown, PA (US)

(21) Appl. No.: 18/485,506

(22) Filed: Oct. 12, 2023

Related U.S. Application Data
(60) Provisional application No. 63/416,695, filed on Oct. 17, 2022.

(51) Int. Cl. B01D 53/04; B01D 53/34; B01D 53/62; B01D 53/78; B01J 20/10; B01J 20/20; F01N 3/28; G07C 5/00

(52) U.S. Cl. CPC B01D 53/0415; B01D 53/0454; B01D 53/346; B01D 53/62; B01D 53/78; B01J 20/103; B01J 20/20; F01N 3/2803; G07C 5/006; B01D 2251/2062; B01D 2253/102; B01D 2253/106; B01D 2257/504; B01D 2258/01; F01N 2370/02

(57) ABSTRACT

The present invention provides a system of capturing carbon dioxide (CO₂) and other gases from combustion engines. The system includes a housing having a plurality of compartments fluidly connected to one another. The housing can be disposed within an exhaust system of a vehicle to capture CO₂ prior to being expelled therefrom. The compartments form a cartridge that is removable from the housing and interchangeable with a second cartridge. Each of the end compartments are closed with a semipermeable filter that allows gases and small molecules to pass through, but not solids or liquids. A first compartment is filled with activated charcoal or silica gel to adsorb CO₂, wherein a second compartment is filled with a nitrogen containing compound, such as ammonia. A chemical reaction occurs between the nitrogen and remaining gases forming an inert byproduct, such as, ammonium carbonate, ammonium bicarbonate, ammonium carbamate, and/or urea.

### CROSS REFERENCE TO RELATED APPLICATION

This application claims the benefit of U.S. Provisional Application No. 63/416,695 filed on Oct. 17, 2022. The above identified patent applications are herein incorporated by reference in their entirety.

### BACKGROUND OF THE INVENTION

The present invention relates to a system for removing carbon dioxide from car exhaust. The present invention further provides a housing having a plurality of compartments fluidly connected to one another and filled with activated charcoal, a nitrogen containing compound, a silica gel, or a combination thereof to adsorb and react with CO₂ and other gases expelled from an exhaust of a motor vehicle.

The increasing levels of carbon dioxide (CO2) in the Earth's atmosphere are a pressing global concern, primarily attributed to human activities such as transportation, industry, and energy production. All motor vehicles release pollutants into the air, mostly through the exhaust fumes that come out of the tailpipe when the engine operates. Pollutants produced by vehicle exhausts include carbon monoxide, hydrocarbons, nitrogen oxides, particles, volatile organic compounds, and sulfur dioxide. Hydrocarbons and nitrogen oxides react with sunlight and warm temperatures to form ground-level ozone. Ground-level ozone, a main ingredient in smog, can cause upper respiratory problems and lung damage.

Traditional carbon capture and storage (CCS) systems have been employed in industrial settings to capture CO2 emissions from power plants and factories. These systems typically use chemical absorbents or adsorbents to capture CO2 before it is released into the atmosphere. While effective, these large-scale solutions are expensive to implement and are not suitable for the mobile nature of vehicles. Direct Air Capture technologies have gained attention for capturing CO2 directly from the ambient air. Although promising, these systems are energy-intensive, often requiring significant power inputs, which makes it impractical for integration into vehicles due to their limited energy resources. Catalytic converters are widely used in vehicles to reduce emissions of harmful pollutants, but they primarily target nitrogen oxides and hydrocarbons, not CO2. Hence, they do not directly address the problem of carbon dioxide emissions.

Some devices exist that are capable of filtering CO₂ and other gases from a vehicle's exhaust. But most of these devices are extremely complex and fail to disclose a system that utilizes a combination of activated charcoal, liquid ammonia, and/or silica gel for the capturing of CO₂. Some devices use algae and sodium hydroxide, which is not very efficient at removing CO₂. Other devices utilize zeolite to adsorb gases. However, zeolite comprises a small surface area of approximately 56 to 60 m²/g, whereas activated charcoal has a surface area of up to 3000 m²/g, which is at least 17 to 18-times higher than the surface area of zeolite. Additionally, the compounds used as an adsorbent or collection method of CO₂, fail to absorb additional compounds such as aromatics, hydrocarbons, methane, and SO₂, NO, and NO₂. Further, many devices cannot be mounted or inserted within the exhaust pipe of a vehicle. Therefore, there exists a need for a system that comprises easily accessible compounds integrated into a series of cylinders for mounting or inserting into an exhaust pipe of a vehicle.

In light of the devices disclosed in the known art, it is submitted that the present invention substantially diverges in design elements and methods from the known art and consequently it is clear that there is a need in the art for an improvement for carbon dioxide removal systems. In this regard the instant invention substantially fulfills these needs.

### SUMMARY OF THE INVENTION

In view of the foregoing disadvantages inherent in the known types of carbon dioxide removal systems now present in the known art, the present invention provides a new carbon dioxide removal system wherein the same can be mounted or inserted into an exhaust system of a vehicle, wherein a combination of activated charcoal, liquid ammonia, and or silica gel are used for the capturing of CO₂ emitted from the vehicle through the exhaust system.

It is an objective of the present invention to provide an embodiment of a carbon dioxide removal system comprising a housing adapted to be inserted within an exhaust system or mounted to an end of an exhaust pipe for receiving the exhaust through the housing as it is dispelled therefrom. In some embodiments, the housing comprises a plurality of compartments fluidly connected to one another each comprising either activated charcoal, ammonia, silica gel, or a mixture of thereof for adsorbing and reacting with CO₂ and other gases.

It is an objective of the present invention to provide an embodiment of a carbon dioxide removal system wherein the housing comprises a pair of compartments disposed at opposing ends of the housing, wherein each end compartment is closed with a semipermeable filter that allows gases and small molecules to pass through, but not solids or liquids.

It is also an objective of the present invention to provide an embodiment of a carbon dioxide removal system wherein the housing comprises first compartment filled with activated charcoal adapted to adsorb gaseous CO₂, a second compartment comprising liquid ammonia configured to react with remaining gases by forming ammonium carbonate, ammonium bicarbonate, ammonium carbamate, and/or urea, and a third compartment filled with a mixture of activated charcoal and ammonia. As the remaining gas passes through the third compartment, a chemical reaction occurs forming organic ammonium molecules.

It is yet another objective of the present invention to provide an embodiment of a carbon dioxide removal system further comprising a sensor disposed within the housing and operably connected to a display to alert a user when the adsorbing materials need to be replaced.

In one embodiment, the system includes a series of three compartments, wherein a first compartment and a third compartment are disposed at opposing ends of the housing. Each of the end compartments are closed with a semipermeable filter that allows gases and small molecules to pass through, but not solids or liquids. The first compartment is filled with activated charcoal adapted to adsorb gaseous CO₂. A middle or second compartment comprises liquid ammonia, wherein a chemical reaction occurs between the ammonia and remaining gases forming ammonium carbonate, ammonium bicarbonate, ammonium carbamate, and/or urea. The third compartment is filled with a mixture of activated charcoal and ammonia.

It is yet another objective of the present invention to provide an embodiment of a carbon dioxide removal system wherein silica gel is used in one of the compartments of the housing and is configured to adsorb CO₂. In some embodiments, the silica gel replaces either the activated charcoal or the ammonia, wherein other embodiments, the silica gel is used in addition to the activated charcoal or the ammonia.

It is therefore an object of the present invention to provide a new and improved carbon dioxide removal system that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of a first end of an embodiment of the carbon dioxide removal system.

FIG. 2 shows a perspective view of a second end of an embodiment of the carbon dioxide removal system.

FIG. 3 shows a perspective view of a cartridge of an embodiment of the carbon dioxide removal system.

FIG. 4 shows a perspective view of an embodiment of the carbon dioxide removal system inserted within an exhaust system of a vehicle.

FIG. 5 shows a cross sectional view of an embodiment of the carbon dioxide removal system within an exhaust system of a vehicle taken along line 5-5 of FIG. 4.

FIG. 6 shows a block diagram of an embodiment of the carbon dioxide removal system.

### DETAILED DESCRIPTION OF THE INVENTION

Reference is made herein to the attached drawings. For the purposes of presenting a brief and clear description of the present invention, the preferred embodiment will be discussed as used for removing CO₂ emitted from an exhaust system using activated charcoal, liquid ammonia, silica gel, or a combination thereof. The figures are intended for representative purposes only and should not be considered to be limiting in any respect.

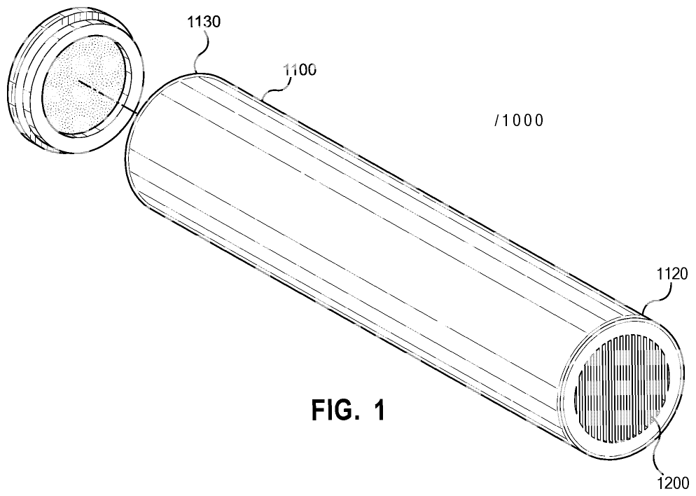

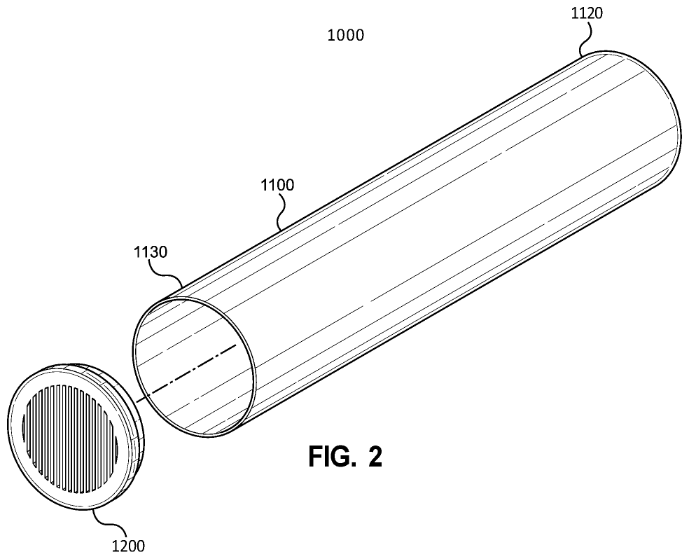

Referring now to FIGS. 1 and 2, there is shown a perspective view of a first end and a second end of an embodiment of the carbon dioxide removal system, respectively. The carbon dioxide removal system 1000 comprises a housing 1100 adapted to be inserted within an exhaust system of a vehicle. The housing is configured to receive a combination of materials that are configured to adsorb and/or react with carbon dioxide, reducing the carbon dioxide emissions from the exhaust system of the vehicle. In the illustrated embodiment, the housing 1100 forms a tubular body having a first end 1120 and an opposing second end 1130. As a result of the high temperature emitted through an exhaust pipe, the illustrated embodiment comprises a housing 1100 composed of a heat-resistant material, such as metal, alloy, graphite, fluoroplastic, and like material capable of maintaining structural integrity when exposed to a range of temperatures. Some heat resistant materials are more suitable for embodiments of the carbon dioxide removal system configured to mount to an exhaust pipe ranging between 300° F. and 500° F. or 149° C. to 260° C., whereas other heat resistant materials are more suitable for embodiments configured to mount to an exhaust ranging between 600° F. to 930° F. or 316° C. to 482° C.

In the illustrated embodiment, a filtration cap 1200 is disposed at the first and second ends 1120, 1130 of the housing 1100, forming a closure. Each filtration cap 1200 is permeable for gases to receive the CO₂ within the housing 1100 and impermeable for solids and liquids to prevent the carbon dioxide removing materials from escaping the housing 1100. In the illustrated embodiment, the filtration caps are heat-resistant and composed of heat resistant material, such as sintered glass fiber filter discs or porous sinter metal filters. In some embodiments, both the housing 1100 and the filtration caps 1200 are configured to withstand a temperature of up to 930 degrees F. At or below those temperatures, the housing 1100 and the filtration caps 1200 retain their structure and form.

In the illustrated embodiment, the filtration cap 1200 disposed on the first end 1120 of the housing 1100 is permanently secured thereto, wherein the filtration cap 1200 disposed on the second end 1130 is removably or pivotally secured to the housing 1100. In alternate embodiments, both filtration caps are removable and in other embodiments, both filtration caps are permanently secured to the housing.

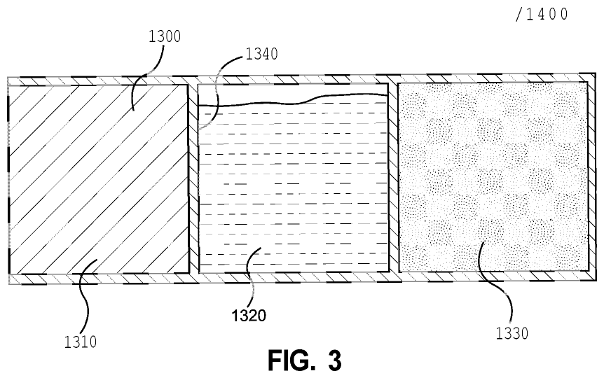

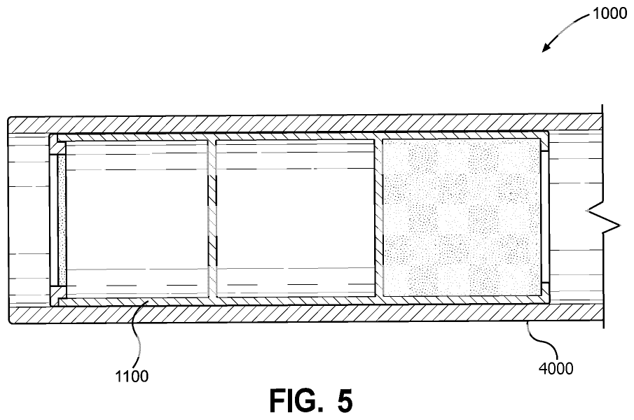

Referring to FIG. 3, there is shown a cross sectional view of a cartridge of an embodiment of the carbon dioxide removal system. The housing 1100 comprises a plurality of compartments 1300 each having a compound configured to adsorb and/or react with carbon dioxide. In the illustrated embodiment, the housing comprises a first compartment 1310, a second compartment 1320, and a third compartment 1330, wherein the second compartment 1320 is disposed between the first and third compartment 1310, 1330 in a linear orientation. In the illustrated embodiment, the compartments 1300 are contained within a cartridge 1400 configured to be insertable and separable from the housing. In alternate embodiments, the cartridge contains a pair of compartments. In other embodiments, the compartments are formed with the housing. In some embodiments, each compartment is formed from a distinct cartridge configured to be inserted or removed from the housing. The compartments 1300 are configured to occupy a substantial (more than 75%) to an entire cross section of the housing to prevent exhaust from bypassing each compartment (as seen in FIG. 5).

Each compartment 1300 is fluidly connected to one another each comprising either activated charcoal, a nitrogen containing compound, silica gel and/or a mixture thereof. In the illustrated embodiment, the first compartment 1310 comprises a solid adsorbent, such as activated charcoal or silica gel. In some embodiments, the silica gel is a synthetic amorphous silica such as Neosyl® GP LC and Gasil® HP260. The activated charcoal and silica gel are each configured to adsorb CO₂. In some embodiments, the first compartment comprises activated charcoal and a second compartment comprises silica gel.

The activated charcoal is in any suitable solid form, such as a powder, granulated material, compressed rods, and the like. The activated charcoal will adsorb CO₂ as it passes through the first compartment of the housing, thereby preventing the CO₂ from dispelling into the air. In the illustrated embodiment, only activated charcoal is disposed within the first compartment, such that the gases from the exhaust are only adsorbed by the activated charcoal and do not have an opportunity to react with other compounds to prevent an undesirable reaction. Besides the removal of CO₂, other environmental harmful components in car exhaust such carbon monoxide (CO), sulfur oxide (SO₂), oxides of nitrogen (NO, N₂O, NO₂), methane (CH₄), hydrogen carbon, and aromatic hydrogen carbon can be removed by adsorption to the activated charcoal.

In the illustrated embodiment, the second compartment 1320 comprises a nitrogen containing compound configured to react with CO₂. In some embodiments, a liquid CO₂ reactor is disposed within the second compartment of the housing. In the shown embodiment, the liquid CO₂ reactor is an aqueous ammonia solution containing up to 35.6% of ammonia. The liquid CO₂ reactor will cause a chemical reaction to occur between the ammonia and remaining gases, including CO₂, forming ammonium carbonate, ammonium bicarbonate, ammonium carbamate, and/or urea. In the illustrated embodiment, only the aqueous ammonia solution is disposed within the second compartment, such that the gases from the exhaust react only with the ammonia and do not have an opportunity to react with other compounds to prevent an undesirable reaction. In some embodiments, a dividing filter 1340 is disposed on each side of the second compartment 1320 to separate the contents disposed within each compartment, while allowing gas to flow through the housing from the first end to the second end.

In the illustrated embodiment, a mixture of the solid adsorbent and the liquid CO₂ reactor is disposed within the third compartment 1330 of the housing. In the shown embodiment, the mixture comprises activated charcoal and an aqueous ammonia solution. As the remaining gas passes through the third compartment, a chemical reaction occurs forming organic ammonium molecules. In some embodiments, the mixture comprises a 1:1 ratio of activated charcoal to ammonia. In alternate embodiments, any suitable ratio of activated charcoal to ammonia is used. However, in alternate embodiments, the solid adsorbent comprises silica gel or a mixture of silica gel and activated charcoal.

In some embodiments, the removal capacity of the nitrogen containing compound configured to react with CO₂ disposed within one of the compartments is between 1 g to 20 g of CO₂ per gram of the nitrogen containing compound. In other embodiments, the removal capacity of ammonia configured to react with CO₂ disposed within one of the compartments is between 3 g to 10 g of CO₂ per gram of ammonia, wherein the ammonia is a liquid solution of 100 mL of ammonium hydroxide ACS solution 28 to 30% mixed with 100 mL purified water.

In some embodiments, the removal capacity of the adsorbent solid disposed within one of the compartments is between 50 g to 500 g of CO₂ per gram of adsorbent solid. In other embodiments, the removal capacity of activated charcoal disposed within one of the compartments is between 100 g to 150 g of CO₂ per gram of activated charcoal. In other embodiments, the removal capacity of silica gel disposed within one of the compartments is between 150 g to 1000 g of CO₂ per gram of silica gel. In other embodiments, the removal capacity of silica gel Neosyl® GP LC disposed within one of the compartments is between 250 g to 450 g of CO₂ per gram of silica gel Neosyl® GP LC. In other embodiments, the removal capacity of silica gel Gasil® HP260 disposed within one of the compartments is between 150 g to 200 g of CO₂ per gram of silica gel Gasil® HP260.

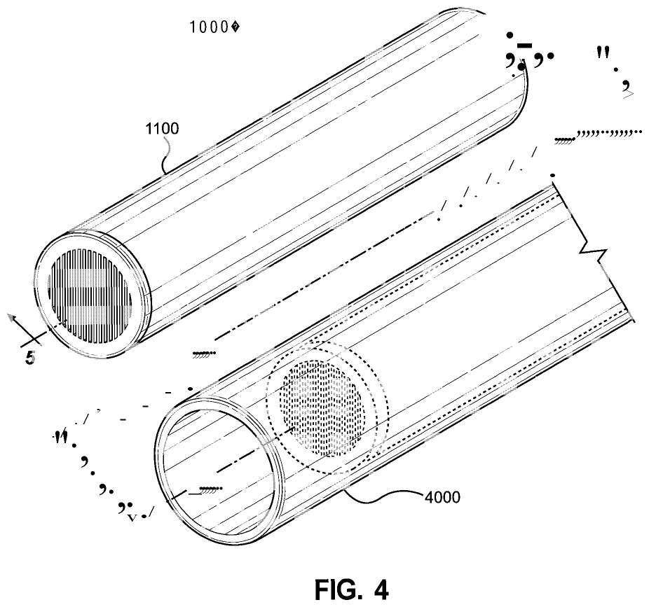

Referring now to FIGS. 4 and 5, there is shown a perspective view and a cross sectional view of an embodiment of the carbon dioxide removal system inserted within an exhaust system of a vehicle, respectively. The housing 1100 is adapted to be mounted within or to the exhaust system of a vehicle. In the illustrated embodiment, the housing 1100 comprises a substantially cylindrical shape configured to correspond with the shape of an interior of an exhaust pipe 4000. However, in alternate embodiments, the housing comprises any suitable shape adapted to be mounted over or inserted within an exhaust pipe or another part of a vehicle's exhaust system. In the illustrated embodiment, the housing 1100 comprises a diameter between 2.0 to 4.5 inches to correspond with the general diameter of an exhaust pipe of a motor vehicle. However, in alternate embodiments, the diameter of the housing is smaller or larger to correspond to the size of a smaller or larger exhaust pipe.

In some embodiments, the housing 1100 comprises a friction fit within the exhaust system, whereas in alternate embodiments, a fastener secures the housing to the exhaust system, such as a clip or screws, or mounts the housing 1100 directly to a distal end of the exhaust pipe.

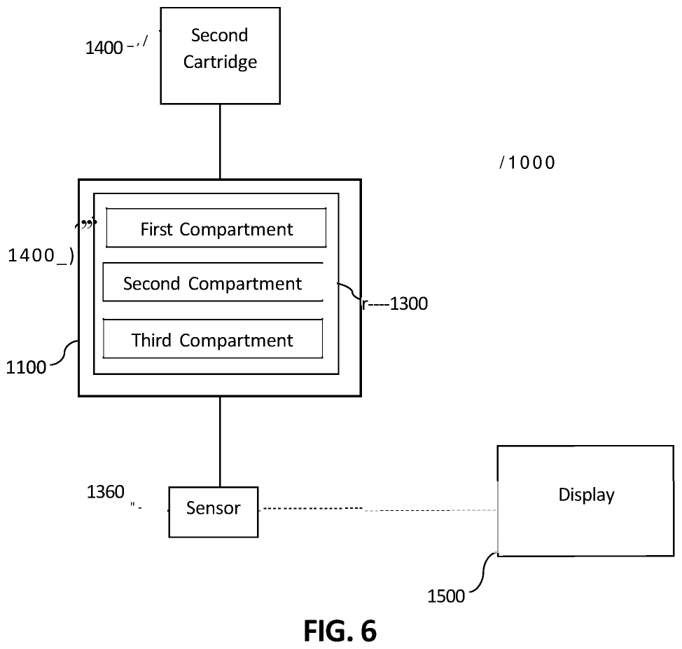

Referring now to FIG. 6, there is shown a block diagram of an embodiment of the carbon dioxide removal system. In the illustrated embodiment, the carbon dioxide removal system further comprises a sensor 1360 operably connected to one or more of the compartments 1300. In some embodiments, each compartment comprises a sensor, wherein the sensor is configured to detect an amount of CO₂ within the compartment. In alternate embodiments, the sensor is configured to detect an amount of active compound within a compartment. Upon reaching a threshold level, the sensor 1360 is configured to send an alert to a secondary device, such as a display on a mobile device or a dashboard display of a vehicle. The alert informs a user that the compartments 1300 are at capacity of use and need to be replaced with a new housing 1100 or cartridge 1400 to be placed within the housing.

In some embodiments, the carbon dioxide removal system is configured to be replaced by a technician at a car dealership or auto mechanic. In other embodiments, the housing is positioned in such a location within the exhaust system that a user or vehicle owner is able to easily access the housing and replace the compartments via replacing the cartridge.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A carbon dioxide removal system, comprising:
a housing comprising a plurality of compartments disposed in a linear orientation along a horizontal axis of the housing;
wherein the plurality of compartments comprise an carbon dioxide adsorbing material and a nitrogen containing compound, wherein the nitrogen containing compound is configured to react with carbon dioxide;
a filtration cap disposed at each end of the housing, wherein the filtration cap is permeable for gases and impermeable for solids and liquids;
wherein both the housing and filtration cap are heat-resistant and configured to retain structural integrity at a temperature of up to 930 degrees F.

2. The carbon dioxide removal system of claim 1, wherein the filter is a sintered glass fiber filter disc.

3. The carbon dioxide removal system of claim 1, wherein the filter is a porous sinter metal filter.

4. The carbon dioxide removal system of claim 1, wherein the carbon dioxide adsorbing material is activated charcoal or silica gel and the nitrogen compound is ammonia.

5. The carbon dioxide removal system of claim 1, wherein the plurality of compartments comprise a first compartment, a second compartment, and a third compartment, wherein the second compartment is disposed between the first and third compartment.

6. The carbon dioxide removal system of claim 5, further comprising a dividing filter disposed at opposing ends of the second compartment to prevent solids and liquids from passing between compartments.

7. The carbon dioxide removal system of claim 5, wherein the carbon dioxide adsorbing material is disposed within the first compartment, the nitrogen containing compound is disposed within the second compartment, and a mixture of the carbon dioxide adsorbing material and the nitrogen containing compound is disposed within the third compartment.

8. The carbon dioxide removal system of claim 7, the carbon dioxide adsorbing material is activated charcoal or silica gel and the nitrogen compound is ammonia.

9. The carbon dioxide removal system of claim 8, wherein the second compartment comprises an aqueous ammonia solution containing up to 35.6% of ammonia.

10. The carbon dioxide removal system of claim 8, wherein the third compartment comprises a mixture of activated charcoal and ammonia.

11. The carbon dioxide removal system of claim 10, wherein the mixture comprises an activated charcoal and ammonia ratio of 1:1.

12. The carbon dioxide removal system of claim 1, wherein the housing is composed of metal.

13. The carbon dioxide removal system of claim 1, wherein the housing is configured to be disposed within an exhaust system of a vehicle.

14. The carbon dioxide removal system of claim 13, wherein the plurality of compartments are formed within a cartridge that is removable from housing.

15. The carbon dioxide removal system of claim 14, wherein the cartridge is interchangeable with a second cartridge that is received by the housing.

16. The carbon dioxide removal system of claim 1, further comprising a sensor operably connected operably connected to the plurality of compartments and configured to send a signal to a display when the cartridge needs to be replaced.

17. The carbon dioxide removal system of claim 16, wherein the display is a mobile device or a dashboard of a vehicle.

18. A method of removing carbon dioxide from an exhaust system of a vehicle, comprising;
providing a carbon dioxide removal system comprising:
a housing comprising a plurality of compartments disposed in a linear orientation along a horizontal axis of the housing;
wherein the plurality of compartments comprise an carbon dioxide adsorbing material and a nitrogen containing compound configured to react with carbon dioxide;
a filtration cap disposed at each end of the housing, wherein the filtration cap is permeable for gases and impermeable for solids and liquids;
wherein both the housing and filtration cap are heat-resistant and configured to withstand a temperature of up to 930 degrees F.;
installing the housing within the exhaust system of the vehicle;
detecting the amount of carbon dioxide disposed within the plurality of compartments via a sensor operably connected to the plurality of compartments;
sending a signal upon detection of a threshold carbon dioxide level to a display.

19. The method of claim 18, further comprising replacing the plurality of compartments with a second plurality of compartments.

20. The method of claim 18, wherein the carbon dioxide adsorbing material is activated charcoal or silica gel and the nitrogen compound is ammonia.
